(19) United States
(12) Patent Application Publication
(10) Pub. No.: US 2017/0163958 A1
(43) Pub. Date: Jun. 8, 2017

(54) METHOD AND DEVICE FOR IMAGE RENDERING PROCESSING

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Xuelian HU, Tianjin (CN)

(21) Appl. No.: 15/249,738

(22) Filed: Aug. 29, 2016

Related U.S. Application Data
(63) Continuation of application No. PCT/CN2016/089266, filed on Jul. 7, 2016.

(30) Foreign Application Priority Data
Dec. 4, 2015 (CN) 201510884372.X

(51) Int. Cl. H04N 13/00; H04N 13/04

(52) U.S. Cl. CPC H04N 13/0007; H04N 13/0468

(57) ABSTRACT

The embodiment of the present disclosure discloses a method and a device for image rendering processing. The method comprises the following steps: detecting states of a target head to generate a target state sequence; determining a state of the target head according to the target state sequence; if the target head is in a stable state, acquiring a quasi-scene image generated in advance from a scene cache region, and taking the acquired quasi-scene image as a target scene image; rendering, a video frame image on the basis of the target scene image to generate a rendered image. According to an embodiment of the present disclosure, as the states of the target head are detected, a scene rendering procedure may be canceled if the target head is in the stable state, the image rendering time may be shortened, the image rendering efficiency may be improved.

### CROSS-REFERENCE TO RELATED APPLICATIONS

The present disclosure is a continuation of International Application No. PCT/CN2016/089266 filed on Jul. 7, 2016, which is based upon and claims priority to Chinese Patent Application No. 201510884372.X, entitled “METHOD AND DEVICE FOR IMAGE RENDERING PROCESSING”, filed on Dec. 4, 2015, and the entire contents of all of which are incorporated herein by reference.

### TECHNICAL FIELD

The present disclosure generally relates to the technical field of virtual reality, and in particular to a method and a device for image rendering processing.

### BACKGROUND

Virtual Reality (VR) is also called Virtual Reality Technology or Virtual Reality Technology, and is a multi-dimensional environment of vision, hearing, touch sensation and the like partially or completely generated by a computer. By auxiliary sensing equipment such as a hamlet display and a pair of data gloves, a multi-dimensional man-machine interface for observing and interacting with a virtual environment is provided, a person may be enabled to enter the virtual environment to directly observe internal change of an article and interact with the article, and a reality sense of “being personally on a scene” is achieved.

Along with rapid development of the VR technology, a VR cinema system based on a mobile terminal is also rapidly developed. In the VR cinema system based on the mobile terminal, a view angle of an image may be changed by head tracking, the visual system and the motion perception system of a user may be associated, and thus relatively real sensation may be achieved. To achieve a relatively good image display effect, the VR cinema system based on the mobile terminal needs to continuously render images in real time, that is, render scene images and video frame images. However, in the process of realizing the present disclosure, the inventor finds that the image rendering calculation quantity is very large, which results rendered images cannot be rapidly generated, that is, the flame ate of the mobile terminal in displaying images is relatively low.

### SUMMARY

The embodiment of the present disclosure aims to solve the technical problems of disclosing a method image rendering processing, improving the image rendering efficiency; achieving the purpose of real-time rendering and thereby increasing the frame rate of a mobile terminal displayed image.

Correspondingly, the embodiment of the present disclosure further provides a device for image rendering processing to ensure realization and application of the method.

According to an embodiment of the present disclosure, there is provided a method for image rendering processing, including:

detecting a state of a target head to generate a target state sequence;

determining the state of the target head according to the target state sequence;

if the target head is in a stable state, acquiring a quasi-scene image generated in advance from a scene cache region, and taking the acquired quasi-scene image as a target scene image;

rendering a video frame image on the basis of the target scene image to generate a rendered image.

According to an embodiment of the present disclosure, there is provided an electronic device for image rendering processing, including:

at least one processor; and a memory communicably connected with the at least one processor for storing instructions executable by the at least one processor, wherein execution of the instructions by the at least one processor causes the at least one processor to:

detect a state of a target head to generate a target state sequence;

determine the state of the target head according to the target state sequence;

acquire a quasi-scene image generated in advance from a scene cache region if the target head is in a stable state, and taking the acquired quasi-scene image as a target scene image;

render a video frame image on the basis of the target scene image to generate a rendered image.

According to an embodiment of the present disclosure, there is provided a computer program, which includes computer readable codes for enabling a mobile terminal to execute the method for image rendering processing above when the computer readable codes are operated on the mobile terminal.

According to an embodiment of the present disclosure, there is provided a non-transitory computer readable medium storing executable instructions that, when executed by an electronic device, cause the electronic device to: detect a state of a target head to generate a target state sequence; determine the state of the target head according to the target state sequence; acquire a quasi-scene image generated in advance from a scene cache region if the target head is in a stable state, and taking the acquired quasi-scene image as a target scene image; render a video frame image on the basis of the target scene image to generate a rendered image.

Compared with the prior art, the embodiment of the present disclosure has the following advantages:

according to the embodiment of the present disclosure, states of a target head are detected, a quasi-scene image generated in advance is acquired from a scene cache region if the target head is in a stable state, the acquired quasi-scene image is taken as a target scene image, and a video frame image is rendered to generate a rendered image, so that a scene rendering procedure may be canceled if the target head is in the stable state, the image rendering time may be shortened, the image rendering efficiency may be improved, the purpose of real-time rendering may be achieved, and moreover the frame rate of a mobile terminal displayed image may be increased.

### BRIEF DESCRIPTION OF THE DRAWINGS

One or more embodiments are illustrated by way of example, and not by limitation, in the figures of the accompanying drawings, Wherein elements having the same reference numeral designations represent like elements throughout. The drawings are not to scale, unless otherwise disclosed.

FIG. 1 shows the flow chart of steps of the method for image rending processing in an embodiment of the present disclosure.

FIG. 2 shows the flow chart of steps of the method for image rending processing in an optimal embodiment of the present disclosure.

FIG. 3A shows the structure diagram of the device for image rending processing in an embodiment of the present disclosure.

FIG. 3B shows the structure diagram of the device for image rendering processing in an optimal embodiment of the present disclosure.

FIG. 4 schematically shows the block diagram of an electronic device for executing the method of the present disclosure.

FIG. 5 schematically shows a storage unit for retaining or carrying program codes for realizing the method of the present disclosure.

### DETAILED DESCRIPTION

To make the purposes, technical schemes and advantages of the embodiments of the present disclosure clearer, the technical schemes in the embodiments of the present disclosure are clearly and completely described with the following figures in the embodiments of the present disclosure, the described embodiments are not all but a part of the embodiments of the present disclosure. Based on the embodiments of the present disclosure, other embodiments obtained by a person skilled in the art under the condition that no creative work is made all belong to the protection scope of the present disclosure.

In a VR cinema system based on a mobile terminal, images need to be continuously rendered in real time, that is, cinema scenes (namely, scene images) and video content (namely, video frame images) are rendered. However, the image rendering calculation quantity is very large, and the frame rate of a mobile terminal displayed image may be affected.

Actually, within a short time after a user starts watching a movie, the user enters into a relatively stable state after the posture is adjusted, and even if the user moves the head sometimes, the state fluctuates within a relatively small range.

Therefore, aiming at the problems, an embodiment of the present disclosure has the key conception that a relatively stable state of the head of the user is monitored, a scene image in the state space is cached as a quasi-scene image, then a scene rendering procedure may be canceled in the image tendering process, the quasi-scene image which is generated in advance may be directly acquired from a scene cache region and may be taken as a target scene image, and the video frame image may be tendered on the basis of the target scene image to generate a rendered image, so that the image rendering efficiency may be improved, the frame time delay caused by image rendering may be shortened, and moreover the frame rate of the mobile terminal displayed image may be increased.

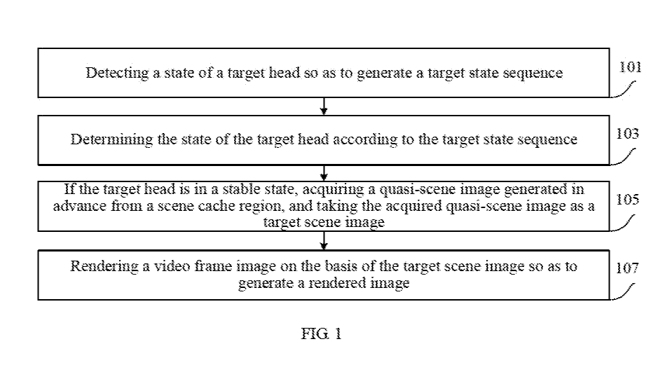

FIG. 1 shows the flow chart of steps of the method for image rending processing in an embodiment of the present disclosure, specifically including the steps as follows.

Step 101. detecting states of a target head to generate a target state sequence.

In a VR cinema system based on a mobile terminal, the view of an image may be changed through head tracking, so that the visual system and the motion perception system of a user may be associated, and thus relatively real sensation may be achieved. Generally, the head of the user may be tracked by using a position tracker, and thus the moving state of the head of the user may be determined, wherein the position tracker is also called as a position tracking device which refers to a device for space tracking and positioning, the position tracker is generally used together with other VR equipment such as a data hamlet, sterioscopic glasses and data gloves, and then a participant may freely move and turn around in a space without being restricted in a fixed spatial position. The VR system based on the mobile terminal may determine the state of the head of the user by detecting the state of the head of the user, the field angle of an image may be determined on the basis of the state of the head of the user, and a relatively good image display effect may be achieved by rendering the image according to the determined field angle. What needs to be explained is that the mobile terminal refers to computer equipment which may be used in a moving state, such as a smart phone, a notebook computer and a tablet personal computer, which is not restricted in the embodiment of the present disclosure. In the embodiment of the present disclosure, a mobile phone is taken as an example to specifically describe the embodiment of the present disclosure.

As a specific example of an embodiment of the present disclosure, the VR system based on the mobile phone may be adopted to monitor the moving state of the head of the user by using auxiliary sensing equipment such as the hamlet, the sterioscopic glasses and the data gloves, that is, the head of the monitored user is taken as a target head of which the states are monitored to determine state information of the target head relative to the display screen of the mobile phone. Based on corresponding state information of the target head, state data corresponding to a current state of the user may be acquired by calculation. For example, after the user wears a data hamlet, an angle of the target head relative to the display screen of the mobile phone may be calculated by monitoring turning states of the head (namely, the target head) of the user, that is, state data may be generated. Specifically, the angle of the target head relative to the display screen of the mobile phone may be generated by calculation according to any one or more data such as a head direction, a moving direction and a moving speed corresponding to a current state of the user.

By adopting the VR system, the generated state data may be stored in a corresponding state sequence to generate a target state sequence corresponding to the target head, for example, angles of the target head A relative to the display screen of the mobile phone at different moments are sequentially stored in corresponding state sequences to form a target state sequence LA corresponding to the target head A. n state data may be stored in the target state sequence LA, and n is a positive integer such as 30, 10 or 15, which is not restricted in the embodiment of the present disclosure.

In an optimal embodiment of the present disclosure, the step 101 may also include the following sub-steps:

sub-step 1010, acquiring data acquired by a sensor to generate state data corresponding to the target head;

sub-step 1012, generating a target state sequence according to the generated state data,

Step 103, determining the states of the target head according to the target state sequence.

Actually, whether the target head enters into a relatively stable state or not may be determined by monitoring the states of the target head in real time, that is, whether the target head stills relative to the display screen of the mobile phone or not is determined. The VR system may determine whether the target head enters into the stable state or not according to the state data in the target state sequence corresponding to the target head. Specifically, the VR system may determine the states of the target head by determining whether the state data stored in the target state LA change within a preset stable state range or not on the basis of all state data stored in the target state sequence LA, that is, whether a target is in a stable state or a moving state synchronously or not may be determined. In the VR cinema system, whether the target head is in the stable state or not may be determined by determining whether a state difference (equivalent to the change range of the state data) corresponding to the target state sequence is within the preset stable state range or not. When the state difference corresponding to the target state sequence is within the preset stable state range, the situation that the target head is in the stable state may be determined. For example, whether the angle change range (namely, the state present disclosure) of the target head relative to the display screen of the mobile phone is within the preset stable state range or not may be determined; if the angle change range of the target head relative to the display screen of the mobile phone is within the preset stable state range, the situation that the target head is in the stable state may be determined, that is, the target head stills relative to the display screen of the mobile phone, or else the situation that the target head is in the moving state, that is, the target head moves relative to the display screen of the mobile phone.

Optionally, the step 103 may specifically include: counting the state data of the target state sequence to determine a state difference; determining whether the state difference is within the preset stable state range or not; when the state difference is within the preset stable state range, determining that the target head is in the stable state.

Step 105, if the target head is in the stable state, acquiring a quasi-scene image generated in advance from a scene cache region, and taking the acquired quasi-scene image as a target scene image.

Specifically, in the image rendering process, the VR cinema system may render a current scene by using a scene model to generate a scene image of the current scene, and the generated scene image may be stored. After adjusting the watching posture, the user enters into a relatively stable state, that is, the target head enters into the stable state. At the moment, the scene image of the current scene, which is generated by using the scene model, may be taken as the quasi-scene image which is stored in the scene cache region. Therefore, if the target head is in the stable state, the quasi-scene image generated if the target head enters into the stable state may be directly extracted from the scene cache region, the extracted quasi-scene image may be taken as a target scene image, then the target image may be rendered, at the same time the procedure of rendering the scene may be canceled, and the image rendering efficiency may be improved.

Step 107, rendering a video frame image on the basis of the target scene image to generate a rendered image.

Actually, in the image rendering process, the VR cinema system may take an image rendered at present as a target image, and the scene of the target image is taken as a target scene. After the scene image of the target scene is generated, that is, after the target scene image is generated, the VR cinema system renders a video frame image corresponding to the target image on the basis of the target scene image to generate a rendered image corresponding to the target image and complete rendering on the target image. Specifically, after the target scene image is generated, the VR cinema system may display a rectangle in a fixed position on the screen, the video frame image may be rendered to the rectangle, and then the rendered image may be generated, and one time of image rendering may be completed.

In the embodiment of the present disclosure, the VR cinema system based on the mobile terminal may detect the states of the target head to generate the target state sequence, and determine the states of the target head according to the target state sequence; if the target head is in the stable state, the quasi-scene image generated in advance may be acquired from the scene cache region, the acquired quasi-scene image is taken as the target scene image to render the video frame image to generate the rendered image, then the scene rendering procedure may be canceled, the image rendering efficiency may be improved and the purpose of real-time rendering may be achieved.

In an optimal embodiment of the present disclosure, the method of image rendering process further includes a step of generating the quasi-scene image. The step of generating the quasi-scene image may include: if the target head enters into the moving state, rendering the current scene on the basis of the scene model to generate the quasi-scene image, and storing the generated quasi-scene image in the scene cache region.

Specifically, in the image rendering process, when determining that the target head enters into the stable state, the VR cinema system may call the scene model to render a scene to be rendered on the basis of the scene model to generate the scene image of the current scene, the scene image may be taken as the quasi-scene image corresponding to the stable state, and the quasi-scene image is stored in the scene cache region. Therefore, the VR cinema system may directly extract the quasi-scene image corresponding to the stable state from the scene cache region and take the quasi-scene image as the target scene image, then the scene rendering procedure may be canceled if the target head is in the stable state, that is, the scene rendering time is shortened by about more than 50%.

Obviously, in the embodiment of the present disclosure, as the scene rendering procedure is canceled, and the image rendering time is shortened, that is, image rendering delay is reduced, and the frame rate of the mobile terminal display image is increased, the problem that the user feels dizzy because of rendering delay may be solved, that is, a relatively good image display effect may be achieved, and the user experience may be improved.

FIG. 2 shows the flow chart of steps of the method for image rending processing in an optimal embodiment of the present disclosure, specifically including the steps as follows.

Step 201, acquiring data acquired by a sensor to generate state data corresponding to the target head.

Actually, VR equipment such as the data hamlet, the sterioscopic glasses and the data gloves for monitoring the target head generally acquires data through the sensor. Specifically, a mobile phone posture (namely, a screen direction) may be detected by using a gyroscope and acceleration and a moving direction of the mobile may be detected by using an accelerometer, wherein the screen direction is equivalent to the head direction. For example, after the head direction is determined, field angles of left and right eyes may be calculated by the VR system based on the mobile phone according to parameters such as upper, lower, left and right view ranges of the left and right eyes, and furthermore an angle of the target head relative to the display screen may be determined according to the field angles of the left and right eyes, that is, the state data are generated.

Step 203, generating the target state sequence according to the generated state data.

The VR system may sequentially store the generated state data into corresponding state sequences and generate the target state sequence corresponding to the target head, for example, angles N1, N2, N3 . . . Nn of the target head A relative to the display screen of the mobile phone at different moments may be sequentially stored in a corresponding state sequence LA, that is, the target state sequence LA corresponding to the target head A may be generated. To ensure the efficiency of image rendering and the precision of the calculated field angle of the target scene, preferably the target state sequence LA is set in a mariner that sequences of 15 state data N may be stored, that is, 15 newly generated state data N may be stored in the target state sequence LA.

Specifically, within 1 second, a plurality of data may be acquired by the sensor, a plurality of state data may be generated by the VR system based on the mobile phone, the plurality of state data generated within every X second may be counted by the VR system to generate the average value N of all state data generated within every X second, and the average value N may be stored, that is, the average value N is stored in the sequence, wherein X is an integer such as 1, 2, 3 and 4. For example, the average value N of state data obtained every 4 seconds is stored into a sequence including 15 state data to generate a target state sequence LA.

Step 205, counting the state data of the target state sequence to a state difference.

In an optimal embodiment of the present disclosure, the step 205 may include the sub-steps as follows.

Sub-step 2050, calculating the state data of the target state sequence to determine a maximum value, a minimum value and an average value of the target state sequence.

Actually, all state data in the target state sequence LA may be compared to determine a minimum value S and a maximum value B of all state data in the target state sequence LA, and an average value M corresponding to all state data in the target state sequence LA may be obtained through calculation.

Sub-step 2052, calculating a first difference between the average value and the maximum value and a second difference between the average value and the minimum value.

Specifically, the difference between the maximum value B and the average value M in the target sequence LA may be obtained through calculation, and the difference of the maximum value B and the average value M is marked as the first difference; and the difference between the minimum value S and the average value M in the target sequence LA may be obtained, and the difference between the minimum value S and the average value M is marked as the second difference.

Sub-step 2052, determining the state difference on the basis of the first difference and the second difference.

The VR system may take the first difference or the second difference as the state difference corresponding to the target head, preferably, a bigger one of the first difference and the second difference is chosen as the state difference corresponding to the target head. Specifically, whether the first difference is bigger than the second difference is determined, and when the first difference is bigger than the second difference, the second difference is taken as the state difference; if the first difference is not bigger than the second difference, the first difference is taken as the state difference.

Step 207, determining whether the state difference is within a preset stable state range or not.

When the state difference is within the stable state, the situation that the target head is in the stable state may be determined, and the step 209 is implemented; when the state difference is not within the stable state range, the situation that the target head is in the moving state may be determined, and the step 211 is implemented.

Actually, the VR cinema system may preset the stable state range which is used for determining whether the target head enters into the stable state or not, that is, whether the target head is in the stable state or not is determined. Specifically, by determining whether the state difference corresponding to the target head is within the preset stable state range, the state of the target head may be determined.

Like the examples above, the state data are the angles of the target head relative to the display screen of the mobile phone, and the state difference is equivalent to a moving angle of the target head relative to the display screen of the mobile phone. The VR system based on the mobile phone may preset the stable threshold as 3 degrees, that is, the preset stable state ranges from 0 degree to 3 degrees. According to the situation that whether the state difference corresponding to the target head is smaller than 3 degrees or not, whether the target head enters into the relative stable state or not may be determined. When the state difference corresponding to the target head is smaller than 3 degrees, the situation that the target, head A is in the stable state may be determined, and the step 209 is implemented; when the state difference is not smaller than 3 degrees, the situation that the target head A is in the moving state may be determined, that is, the target head A quits from the stable state and enters into a normal rendering mode, and the step 211 is implemented.

Step 209, acquiring the quasi-scene image generated in advance from the scene cache region, and taking the acquired quasi-scene image as the target scene image.

If the target head is in the stable state, the VR cinema system may directly acquire the quasi-scene image corresponding to the stable state from the scene cache region and take the acquired quasi-scene image as the target scene image of a current cinema scene, and the target scene image of the target scene may be generated without the scene model, so that the scene rendering procedure of the current scene may be canceled, that is, the step 211 is not implemented but directly skipping to the step 213.

Step 211, rendering the current scene on the basis of the scene model to generate the target scene image.

To obtain a relatively good image display effect and improve the permanent brilliance experience, if the target head is in the moving state, the current cinema scene (namely, the current scene) may be rendered according to the scene model to generate a scene image of the current scene. Specifically, the VR system may take the current scene as the target scene when the current scene is rendered, and the scene model may be called to render the target scene to generate a target scene image.

Step 213, rendering the video frame image on the basis of the target scene image to generate the rendered image.

Specifically, the VR system may render the video frame image corresponding to the target scene to a rectangle of the target scene image on the screen to generate the rendered image corresponding to the target scene, that is, the rendered image is displayed on the display screen.

In the embodiment of the present disclosure, the states of the target head may be monitored. It the target head is in the stable state, the quasi-scene image corresponding to the stable state may be directly extracted from the scene cache region, the extracted quasi-scene image is taken as the target scene image, that is, the procedure of scene rendering is canceled, the image rendering efficiency is improved, and the image rendering delay is reduced, so that the problem that the user feels dizzy because of rendering delay is solved, that is, a relatively good image display effect is achieved, and the user experience is improved.

What needs to be explained is that to be described concisely, the method in the embodiments is expressed as a combination of a series of action, however a person skilled in the art shall understand that the embodiment of the present disclosure is not restricted by the sequence of the described action as some steps may be implemented in other sequences or simultaneously in the embodiments of the present disclosure. Secondly, the person skilled in the art shall also understand that the embodiments in the present disclosure are all optimal embodiments, and action involved in the embodiments is not definitely essential in the embodiments of the present disclosure.

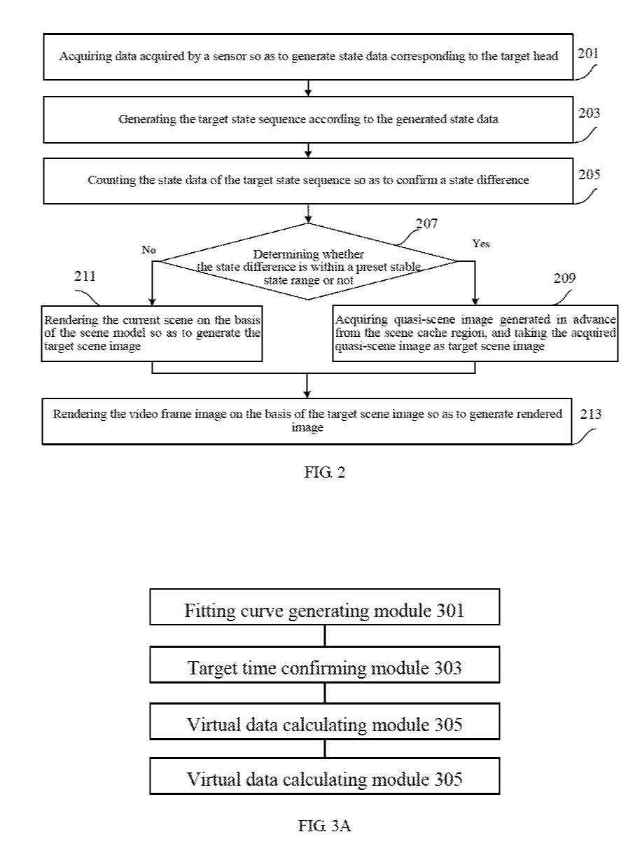

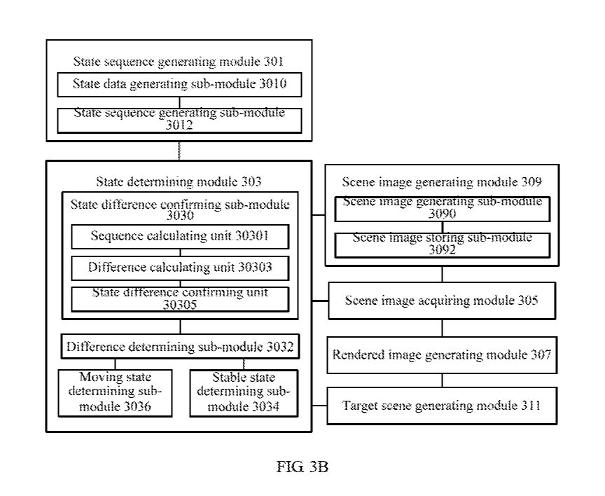

FIG. 3A shows the structure diagram of the device for image rending processing in an embodiment of the present disclosure, specifically including the following modules:

a state sequence generating module 301 for detecting states of a target head to generate a target state sequence;

a state determining module 303 for determining the states of the target head according to the target state sequence;

a scene image acquiring module 305 for acquiring a quasi-scene image generated in advance from a scene cache region if the target head is in a stable state, and taking the acquired quasi-scene image as a target scene image;

a rendered image generating module 307 for rendering a video frame image on the basis of the target scene image to generate a rendered image.

On the basis of FIG. 3A, optionally, the device for image rendering processing may further include a scene image generating module 309, see FIG. 3B.

The scene image generating module 309 may be used for generating the quasi-scene image in advance. Optionally, the scene image generating module 309 may include the following sub-modules:

a scene image generating sub-module 3090 for rendering the current scene by using the scene model to generate the quasi-scene image if the target head enters into the moving state;

a scene image storing sub-module 3092 for storing the generated quasi-scene image in the scene cache region.

In an optimal embodiment of the present disclosure, the state sequence generating module 301 may include the following sub-modules:

a state data generating sub-module 3010 for acquiring data acquired by a sensor to generate state data corresponding to the target head;

a state sequence generating sub-module 3012 for generating the target state sequence on the basis of the generated state data.

Optionally, the state determining module 303 may include the following sub-modules:

a state difference determining sub-module 3030 for counting the state data of the target state sequence to determine a state difference.

In an optimal embodiment of the present disclosure, the state difference determining sub-module may include the following units:

a sequence calculating unit 30301 for calculating the state data of the target state sequence to determine a maximum value_{;} a minimum value and an average value of the target state sequence;

a difference calculating unit 30303 for calculating a first difference between the average value and the maximum value and a second difference between the average value and the minimum value;

a state difference determining unit 30305 for determining the state difference on the basis of the first difference and the second difference.

A difference determining sub-module 3032 for determining whether the state difference is within the preset stable state range.

A stable state determining sub-module 3034 for, determining that the target head is in the stable state when the state difference is within the stable state range.

A moving state determining sub-module 3036 for determining that the target head is in the moving state when the state difference exceeds the stable state range.

The device for image rendering processing further includes a target scene generating module 311, wherein the target scene generating module 311 may be used for rendering the current scene on the basis of the scene model to generate the target scene image if the target head is in the moving state.

As the device of the embodiments is generally similar to the method of the embodiments, the device is relatively concisely described, see related parts in description of the method of the embodiments.

The embodiments of the present disclosure are all described in a progressive mode, differences of the embodiments from those of others are particularly described, and refer to one another about similar parts of the embodiments.

A person skilled in the art shall understand that the embodiments of the present disclosure may be provided in manners of methods, devices or computer program products. Therefore, the embodiments of the present disclosure may be complete hardware embodiments, complete software embodiments or embodiments with the combination of software and hardware. Moreover, the embodiments of the present disclosure may be computer program products which are implemented in one or more computer available storage mediums (including but not limited to a disk storage, a CD-ROM, an optimal memory and the like) with computer available program codes.

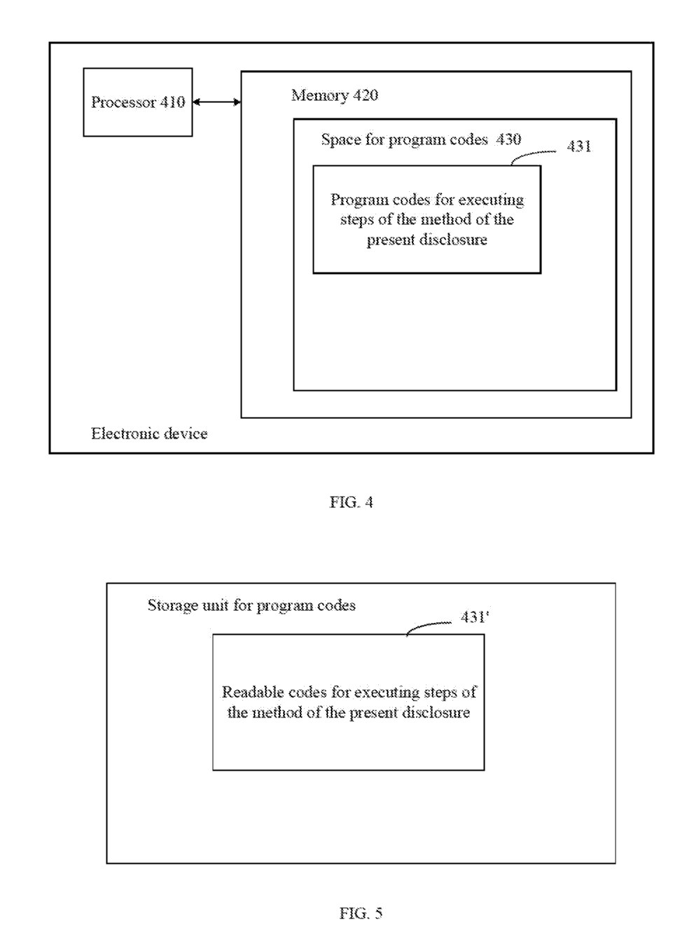

For example, FIG. 4 illustrates a block diagram of an electronic device for executing the method according the disclosure. The electronic device may be the mobile terminal above. Traditionally, the electronic device includes a processor 410 and a computer program product or a computer readable medium in form of a memory 420. The memory 420 could be electronic memories such as flash memory, EEPROM (Electrically Erasable Programmable Read-Only Memory), EPROM, hard disk or ROM. The memory 420 has a memory space 430 for executing program codes 431 of any steps in the above methods. For example, the memory space 430 for program codes may include respective program codes 431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 5. The memory cells may be provided with memory sections, memory spaces, etc., similar to the memory 420 of the electronic device as shown in FIG. 4. The program codes may be compressed for example in an appropriate form. Usually, the memory cell includes computer readable codes 431′ which may be read for example by processors 410. When these codes are operated on the electronic device, the electronic device may execute respective steps in the method as described above.

The embodiments of the present disclosure are described referring to the flow charts and/or block diagrams of the methods, terminal equipment (system) and computer program products of the embodiments of the present disclosure. Do understand that each procedure and/or block in the flow charts and/or block diagrams and combinations of procedures and/or blocks in the flow charts and/or the block diagrams may be realized by using computer program instructions. The computer program instructions may be provided into a processor of a general-purpose computer, a special computer, a built-in processor or other programmable data processing terminal equipment to generate a machine which enables instructions executed by the processor of the computer or other programmable data processing terminal equipment to generate a device for realizing functions appointed in one procedure or multiple procedures in the flow charts and/or one block or multiple blocks in the block diagrams.

The computer program instructions may be also stored in a computer readable memory capable of instructing the computer or other programmable data processing terminal equipment to work in a specific mode, to enable instructions stored in the computer readable memory to generate a product including an instruction device for realizing appointed functions in one procedure or multiple procedures of the flow charts ands or one block or multiple blocks of the block diagrams.

The computer program instructions may be also loaded to the computer or other programmable data processing terminal equipment, so that a series Of operation steps may be executed in the computer or other programmable data processing terminal equipment to generate processing realized by the computer, then the instructions executed in the computer or other programmable data processing terminal equipment are used for providing steps for realizing appointed functions in one procedure or multiple procedures of the flow charts and/or one block or multiple blocks of the block diagrams.

Although optimal ones of the embodiments of the present disclosure are described, a person skilled in the art may make additional change and modification to the embodiments once learning basic creative concepts, therefore, claims as follows intend to be interpreted as including the optimal embodiments and all changes and modifications within the scope of the embodiments of the present disclosure.

The final description is that in the text, the relationship terms such as the first and the second are only used for distinguishing one entity or operation from another entity or operation but not requiring or hinting that the entity or operation has the actual relationship or sequence. In addition, the terms “comprise”, “include” or any other variant intend to cover nonexclusive inclusion, so that procedures, methods, products or devices including a series of elements not only include the elements, but also other elements which are not specifically listed, or include inherent elements of the procedures, the methods, the products or the devices. Under the condition of no more limit, elements defined in the sentence “include one . . . ” do not exclude that the procedures, the methods, the products or the devices including the elements also have other identical elements.

The method for image rendering processing and the device for image rendering processing, which are provided by the present disclosure, are specifically described, specific examples are taken to explain principles and modes of execution of the present disclosure in the text, and the description about the embodiments is only to promote understanding about the methods and the key concepts of the present disclosure; meanwhile a person skilled in the art may make change on specific modes of execution and application ranges on the basis of the concepts of the present disclosure, and to sum up, the content of the specification shall not be interpreted as restriction on the present disclosure.

What is claimed is:

1. A method for image rendering processing, at an electronic device, comprising:
detecting a state of a target head to generate a target state sequence;
determining the state of the target head according to the target state sequence;
if the target head is in a stable state, acquiring a quasi-scene image generated in advance from a scene cache region, and taking the acquired quasi-scene image as a target scene image;
rendering a video frame image on the basis of the target scene image to generate a rendered image.

2. The method according to claim 1, wherein detecting the state of the target head to generate the target state sequence comprises:
acquiring data acquired by a sensor to generate state data corresponding to the target head;
generating the target state sequence according to the generated state data.

3. The method according to claim 2, wherein determining the state of the target head according to the target state sequence comprises:
counting the state data of the target state sequence to determine a state difference;
determining whether the state difference is within a preset stable state range or not;
when the state difference is within the preset stable state range, determining that the target head is in the stable state.

4. The method according to claim 3, wherein counting the state data of the target state sequence to determine the state difference comprises:
calculating the state data of the target state sequence to determine a maximum value, a minimum value and an average value of the target state sequence;
calculating a fast difference between the average value and the maximum value and a second difference between the average value and the minimum value;
determining the state difference on the basis of the first difference and the second difference.

5. The method according to claim 3, wherein determining the state of the target head according to the target state sequence further comprises:
determining that the target head is m a moving state when the state difference exceeds the stable state range;
the method further comprising:
rending a current scene on the basis of a scene model to generate a target scene image if the target head is in the moving state.

6. The method according to claim 1, further comprising a step of generating a quasi-scene image in advance, which comprises:
rendering the current scene on the basis of the scene model to generate the quasi-scene image if the target head enters into the moving state;
storing the generated quasi-scene image in the scene cache region.

7. An electronic device for image rendering processing, comprising:
at least one processor; and
a memory communicably connected with the at least one processor for storing instructions executable by the at least one processor, wherein execution of the instructions by the at least one processor causes the at least one processor to:
detect a state of a target head to generate a target state sequence;
determine the state of the target head according to the target state sequence;
acquire a quasi-scene image generated in advance from a scene cache region if the target head is in a stable state, and taking the acquired quasi-scene image as a target scene image;
render a video frame image on the basis of the target scene image to generate a rendered image.

8. The electronic device according to claim 7, wherein the step to detect a state of a target head to generate a target state sequence comprises:
acquire data acquired by a sensor to generate state data corresponding to the target head;
generate the target state sequence on the basis of the generated state data.

9. The electronic device according to claim 8, wherein the step to determine the state of the target head according to the target state sequence comprises:
count the state data of the target state sequence to determine a state difference;
determine whether the state difference is within a preset stable state range or not;
determine that the target head is in the stable state when the state difference is within the stable state range.

10. The electronic device according to claim 9, wherein the step to count the state data of the target state sequence to determine a state difference comprises:
calculate the state data of the target state sequence to determine a maximum value, a minimum value and an average value of the target state sequence;
calculate a first difference between the average value and the maximum value and a second difference between the average value and the minimum value;
determine the state difference on the basis of the first difference and the second difference.

11. The electronic device according to claim 9, wherein the step to count the state data of the target state sequence to determine a state difference comprises: determine that the target head is in a moving state when the state difference exceeds the stable state range;
execution of the instructions by the at least one processor further causes the at least one processor to: rend a current scene on the basis of a scene model to generate a target scene image if the target head is in the moving state.

12. The electronic device according to claim 7, wherein execution of the instructions by the at least one processor further causes the at least one processor to: generate a quasi-scene image in advance,
the step to generate a quasi-scene image in advance comprising:
render the current scene on the basis of the scene model to generate the quasi-scene image if the target head enters into the moving state;
store the generated quasi-scene image in the scene cache region.

13. A non-transitory computer readable medium storing executable instructions that, when executed by an electronic device, cause the electronic device to:
detect a state of a target head to generate a target state sequence;
determine the state of the target head according to the target state sequence;
acquire a quasi-scene image generated in advance from a scene cache region if the target head is in a stable state, and taking the acquired quasi-scene image as a target scene image;
render a video frame image on the basis of the target scene image to generate a rendered image.

14. The non-transitory computer readable medium according to claim 7, wherein the step to detect a state of a target head to generate a target state sequence comprises:
acquire data acquired by a sensor to generate state data corresponding to the target head;
generate the target state sequence on the basis of the generated state data.

15. The non-transitory computer readable medium according to claim 14, wherein the step to determine the state of the target head according to the target state sequence comprises:
count the state data of the target state sequence to determine a state difference;
determine whether the state difference is within a preset stable state range or not;
determine that the target head is in the stable state when the state difference is within the stable state range.

16. The non-transitory computer readable medium according to claim 15, wherein the step to count the state data of the target state sequence to determine a state difference comprises:
calculate the state data of the target state sequence to determine a maximum value, a minimum value and an average value of the target state sequence;
calculate a first difference between the average value and the maximum value and a second difference between the average value and the minimum value;
determine the state difference on the basis of the first difference and the second difference.

17. The non-transitory computer readable medium according to claim 15, wherein the step to count the state data of the target state sequence to determine a state difference comprises: determine that the target head is in a moving state when the state difference exceeds the stable state range;
the electronic device is further caused to: rend a current scene on the basis of a scene model to generate a target scene image if the target head is in the moving state.

18. The non-transitory computer readable medium according to claim 13, wherein the electronic device is further caused to:
generate a quasi-scene image in advance, which comprises:
rendering the current scene on the basis of the scene model to generate the quasi-scene image if the target head enters into the moving state;
storing the generated quasi-scene image in the scene cache region.
